(19) United States
(12) Patent Application Publication
(10) Pub. No.: US 2020/0007336 A1
(43) Pub. Date: Jan. 2, 2020

(54) Blockchain Powered Data Consortium for Verifying Smart Resumes and Degree Certificates

(71) Applicant: David Wengel, Little Rock, AR (US)

(72) Inventor: David Wengel, Little Rock, AR (US)

(21) Appl. No.: 16/458,430

(22) Filed: Jul. 1, 2019

Related U.S. Application Data
(60) Provisional application No. 62/692,373, filed on Jun. 29, 2018.

(51) Int. Cl. H04L 9/32; H04L 29/08; H04L 9/06; G06F 16/182; H04N 1/00

(52) U.S. Cl. CPC H04L 9/3226; H04L 67/06; G06Q 10/1053; G06F 16/1824; H04N 1/00244; H04L 9/0637

(57) ABSTRACT

Systems and methods for generating, presenting, and transmitting smart resumes that may have personally identifiable information hidden, but the remainder of the resume may be visible and include key elements (such as educational degrees, honors received, recommendations/references received, professional history) that may be verified by blockchain/distributed ledger technology. Partner companies may select a portion of the resume, such as a logo or icon, to verify that the user is credentialed on the platform and that select elements of the resume are verified. This verification allows companies to review blinded resumes with confidence knowing that the key underlying resume elements are factual even though they do not know the identity of the resume holder.

### CROSS-REFERENCE TO RELATED APPLICATIONS

This claims the benefit of U.S. Provisional Patent Application No. 62/692,373, filed on Jun. 29, 2018. The entire contents of that application are incorporated herein by reference.

### BACKGROUND OF THE INVENTION

Companies grapple with the issue of employees demonstrating conscious or unconscious bias in the resume review portion of the hiring process. Employees that engage in either conscious or unconscious bias may do so because they do not want to work with an applicant whose gender, ethnicity, age, race or perceived religious beliefs do not fit their ideal candidate. This bias may lead to not only illegal discrimination, but it also may inhibit the company from recruiting a diverse workforce chosen based on skills and merit, and realizing the benefits of such a diverse workforce.

Because hiring managers often succumb to conscious or unconscious bias in hiring decisions, some companies hire expensive independent consultants to attempt to “re-wire” hiring managers to think differently when analyzing traditional resumes. This is not only an expensive process, but also an ineffective one. Human nature is very difficult to change. If someone is biased, they are not likely to admit it, want to change, or easily make a change.

Companies also struggle to identify new job talent in a cost effective and efficient manner. New job talent may include individuals who have just completed a high school degree, a 2 year degree program, a 4 year undergraduate degree, a graduate degree, or a professional certification program that recognizes a new skill that the participants receive. Companies spend millions of dollars to send employees to interview new job talent at colleges and universities, while also hiring recruiters to find the talent they cannot find directly themselves. Companies that specialize in recruiting new hires for other companies are also constantly in search of new job talent that may meet their clients' needs, but their accessible pool of talent is often limited to their existing networking environment.

Companies also struggle to make sure that they are doing the appropriate amount of due diligence on new hires. For example, trucking companies face steep fines and potential litigation if they hire a driver who has a history of serious driving infractions, and that driver then causes another major incident for their new employer. Companies need more innovative ways to pre-screen employees.

Companies have struggled to develop a cost effective and compliant approach to performing due diligence on new hires. Adequate due diligence has been a tedious process for human resources to verify the academic or listed professional accomplishments and/or background of an individual applicant.

Companies have also had to rely on expensive recruiters, inefficient college outreach to numerous career services departments and/or rely on unverified applicant-provided information on individual resumes or social media profiles such as LinkedIn. Recruiters have to pay very high fees to services such as LinkedIn to find new job talent and none of the user profiles on that platform are verified, putting the reputation of the recruiters at risk if they refer a candidate with false or inflated information on their resume.

Companies may also struggle to find new job talent in a competitive job market. Even if they spend significant dollars to identify new job talent via paid recruiters, career services, online job boards and traditional advertising (print, TV, radio, newspaper, billboards, etc.) to raise awareness, none of these approaches guarantee success and certainly none of them do a good job of assessing new job talent. Current professional networking and career placement companies such as LinkedIn, Monster, and CareerBuilder provide no assurance to their company partners that the resume information of applicants is accurate or truthful. This is a huge problem and weakness given that the primary value proposition of their business is to help companies find great job applicants. Further, smaller companies are at a further disadvantage because they do not have the funds or human resources to cast a wider net to find new talent.

Some companies pay expensive third party education verification consultants to do “education background checks” on potential applicants. This is an expensive and tedious process where the third party consultants call the individual schools listed on an applicant's resume to verify key resume assertions by the applicant. This approach can slow down the recruiting process and lead to a company losing out on a candidate if they are not able to verify the applicant's credentials in time.

Colleges and universities are increasingly struggling to justify the return on educational investment by their students. This challenge is a major problem for thousands of higher education institutions. The majority of students enter higher education because they hope to develop the skills that will lead to a good paying, full-time job. But they do so at a significant financial cost/investment. Colleges and universities seek to help their students and alumni achieve their career goals and thereby justify the expense of their programs.

Colleges and universities have traditionally assisted students looking for jobs by helping them craft a traditional resume and potentially matching them with an employer in their network for an interview. But given their trusted role as an institution of higher learning, these colleges and universities can do so more to assist their students with finding a great job.

Colleges and universities also struggle to accurately verify whether applicants at the undergraduate or graduate level have attained the necessary pre-requisites at other schools to attend their institution. Colleges and universities have not had a standardized way of quickly reviewing the academic credentials of applicants from other schools to determine if they meet their own admissions, or employment, standards.

There has been no standardized third party authentication of an individual's claimed education or professional credentials. Potential employers have had to manually call an applicant's listed school or past employer to attempt to verify the applicant's provided information. Higher education institutions have had to spend hundreds or even thousands of hours per year trying to verify the academic credentials of applying students. This is a very time consuming process because there has been no trusted and automated source of applicant credential verification.

While companies and universities have individually issued blockchain certified diplomas (e.g., The Massachusetts Institute of Technology), there have been no consortiums created that includes multiple different higher education institutions all posting diploma and academic credentials to a distributed ledger that provides functionality to both students/alumni, colleges/universities, and hiring companies/recruiters looking for talent on merit base selection criteria only. There is a clear weakness in the way that companies and universities previously issued blockchain verified diplomas in a “silo'd” basis: (1) blockchain diploma holders are unlikely to send just a diploma to hiring companies, (2) the lack of consortium limits the ability to create a pool of new job talent that trusted hiring companies can search, and (3) there is no way to create an automated verification of student credentials for the higher education institutions themselves if no consortium exists.

There is therefore a need for improved systems and methods that overcome some or all of the previously described drawbacks.

### SUMMARY OF THE INVENTION

The present invention can eliminate the risk of bias against an applicant since they can blind their identity and give extra piece of mind knowing that the anonymous applicant has certified academic and professional attributes.

It is an object of the present invention to enable companies to more efficiently find trusted new job applicant talent by searching a pooled dataset of new talent identified by higher education and continuing education partners.

It is also an object of the present invention to help higher education institutions demonstrate to potential and current students, along with alumni, that they are focused on providing unique tools that will help certify and showcase their students/alumni to interested companies.

It is another object of the present invention to help create a common language and data structure of key academic credentials to help automate verification by higher education institutions themselves.

It is a further object of the present invention to help companies find new verified job talent faster and in a more compliant manner. Companies may access an encrypted dataset of potential job applicants and their verified academic credentials (“Assets”).

It is also an object of the present invention to help companies not only blind their own resumes to prevent conscious and unconscious bias, but also search a pool of smart resumes that have been certified by trusted partners such as accredited higher education institutions.

It is another object of the present invention to help companies not only prove that they are reviewing resumes in a compliant manner (e.g., by removing contact data that can indicate a user's ethnicity, sex, race, religion, etc.), but also review far more new job talent resumes that are certified as containing true information about the user. This may save significant time and expense for companies.

It is a further object of the present invention to give colleges and universities a significant competitive advantage as they can show potential/current students and alumni that they are providing a new type of trusted resume to help students/graduates demonstrate their verified skills and academic accomplishments

It is also an object of the present invention to help colleges and universities standardize a common language amongst higher education institutions to confirm quickly that an applicant, either for education or employment, has attained the educational progress that they claim.

It is another object of the present invention to automatically authenticate an individual's claimed education and/or professional credentials via the participation of a higher education permission-based blockchain consortium. This will save future employers significant time and expense from having to manually verify.

It is also an object of the present invention to both empower smart resume holders to send their own copies of their documents to companies, and also dictate which companies can and cannot contact them about potential employment. A user's information may be encrypted further masking their identity.

The present invention may help companies (both employers and companies specializing in recruiting) scale their search for new job talent through a proprietary data pool created by a custom consortium of multiple higher education institutions. Providing blockchain/distributed ledger technology verified diplomas to higher education partners achieves a verified proof of degree/certification attainment, and may allow certification of the credentials in a graduate's accompanying resume. The present invention creates a smart resume that not only protects the data privacy of the owner by masking their identity with an alphanumeric key, but also certifies their unique academic and professional credentials via a permission blockchain/distributed ledger technology.

Numerous variations may be practiced in the preferred embodiment.

### BRIEF DESCRIPTION OF THE DRAWINGS

A further understanding of the invention can be obtained by reference to embodiments set forth in the illustrations of the accompanying drawings. Although the illustrated embodiments are merely exemplary of systems, methods, and apparatuses for carrying out the invention, both the organization and method of operation of the invention, in general, together with further objectives and advantages thereof, may be more easily understood by reference to the drawings and the following description. Like reference numbers generally refer to like features (e.g., functionally similar and/or structurally similar elements).

The drawings are not necessarily depicted to scale; in some instances, various aspects of the subject matter disclosed herein may be shown exaggerated or enlarged in the drawings to facilitate an understanding of different features. Also, the drawings are not intended to limit the scope of this invention, which is set forth with particularity in the claims as appended hereto or as subsequently amended, but merely to clarify and exemplify the invention.

FIG. 1 depicts an exemplary resume in accordance with the present invention;

FIG. 2 depicts an exemplary resume in accordance with the present invention;

FIG. 3 depicts a flowchart showing exemplary aspects of the present invention;

FIG. 4 depicts a computer interface in accordance with the present invention;

FIG. 5 depicts a computer interface in accordance with the present invention;

FIG. 6 depicts a computer interface in accordance with the present invention;

FIG. 7 depicts a computer interface in accordance with the present invention;

FIG. 8 is a flow chart depicting a method in accordance with the present invention.

### DETAILED DESCRIPTION OF THE INVENTION

The invention may be understood more readily by reference to the following detailed descriptions of embodiments of the invention. However, techniques, systems, and operating structures in accordance with the invention may be embodied in a wide variety of forms and modes, some of which may be quite different from those in the disclosed embodiments. Also, the features and elements disclosed herein may be combined to form various combinations without exclusivity, unless expressly stated otherwise. Consequently, the specific structural and functional details disclosed herein are merely representative. Yet, in that regard, they are deemed to afford the best embodiment for purposes of disclosure and to provide a basis for the claims herein, which define the scope of the invention. It must be noted that, as used in the specification and the appended claims, the singular forms “a”, “an”, and “the” include plural referents unless the context clearly indicates otherwise.

Use of the term “exemplary” means illustrative or by way of example, and any reference herein to “the invention” is not intended to restrict or limit the invention to the exact features or steps of any one or more of the exemplary embodiments disclosed in the present specification. Also, repeated use of the phrase “in one embodiment,” “in an exemplary embodiment,” or similar phrases do not necessarily refer to the same embodiment, although they may. It is also noted that terms like “preferably,” “commonly,” and “typically,” are not used herein to limit the scope of the claimed invention or to imply that certain features are critical, essential, or even important to the structure or function of the claimed invention. Rather, those terms are merely intended to highlight alternative or additional features that may or may not be used in a particular embodiment of the present invention.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

The systems and methods in accordance with the present invention may be used to prepare and share information about a subject (e.g. a person) where the recipient of the information may desire to verify the information, but where it is preferable to conceal the identity of the subject, at least for a period of time. For example, the systems and methods disclosed herein may be used to prepare, present, and distribute a resume and/or provide a means to quickly and easily verify information presented on a resume. Although the systems and methods disclosed herein are described in that context, they may also be used in other contexts.

The present invention may be practiced using a computer system coupled to a computer network. The computer system may include a computer memory having a machine-readable medium comprising machine-executable code recorded thereon. The executable code may have instructions used to practice the inventions disclosed herein.

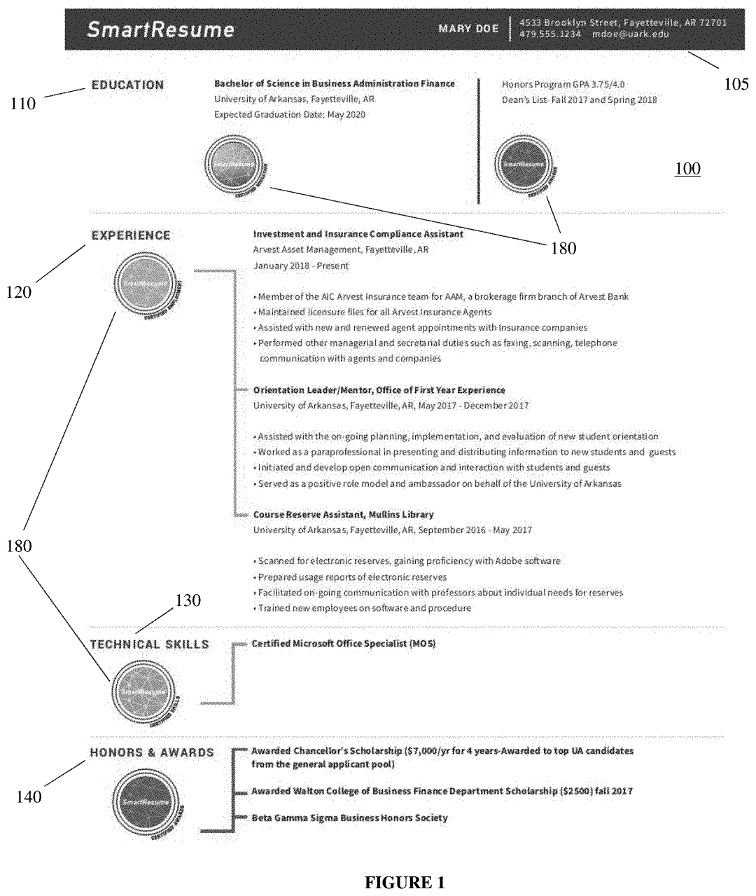

Systems and methods in accordance with the present invention may be used to prepare a resume (100) as shown in FIG. 1. Resume (100) may be a digital document stored in non-transitory memory of the computer system, such as a hard drive, mainframe, or server. Resume (100) may also be stored remotely in a hard drive, mainframe, or server and accessed via the internet or an intranet. Resume (100) may also be stored in a cloud storage facility and accessed via the internet.

Resume (100) may include sections and information typically included on a traditional resume. For example, the top of the resume may include Biographical Section (105) which includes biographical information (also referred to herein as “identifying information,” “personally identifiable information,” or “PII”) about the person (i.e., candidate) about whom the resume (100) is the subject, who is also a user of the computer system described herein. Biographical Section (105) may include information corresponding to the user such as the user's name, the user's address, the user's phone number, and/or the user's email address.

Resume (100) may also include Education Section (110), Experience Section (120), Technical Skills Section (130), and Honors & Awards Section (140). Included in the Education Section (110) may be information concerning one or more schools the user has attended, degrees the user earned, the user's dates of graduation from each school, and honors the user received while attending each school. Experience Section (120) may include information about the user's prior employment history, including companies, organizations, institutions, or other entities where the user has been employed, the user's dates of employment at each, and the titles of employment that the user held. Technical Skills Section (130) may include information about skills the user has acquired, including certifications attesting to the user's skills. Honors & Awards Section (140) may include honors that the user has received. Other exemplary resume sections also include Leadership and References. Resume (100) may also include icons (180) next to each section indicating that the information presented has been verified, as discussed further below.

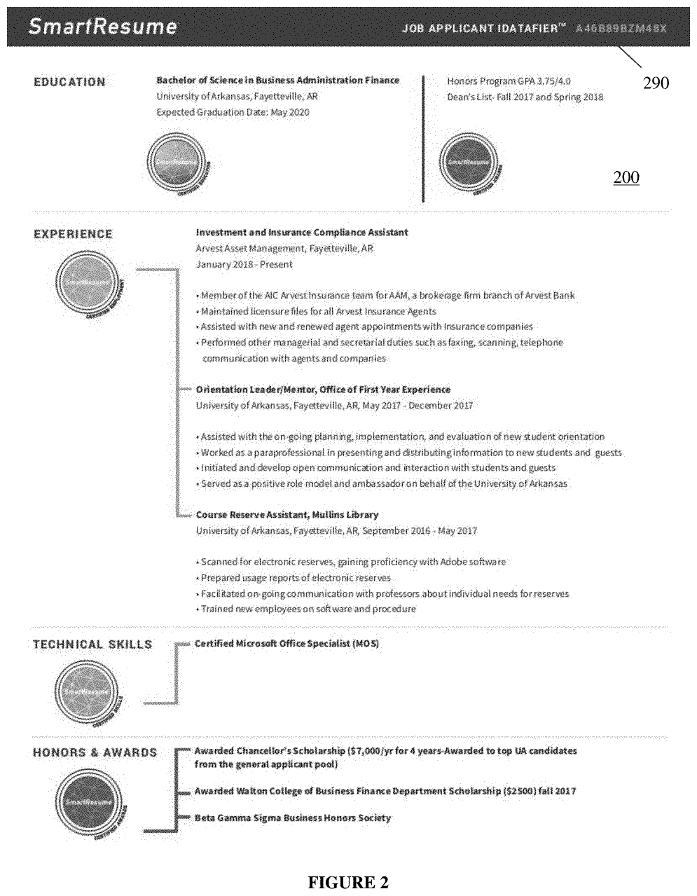

FIG. 2 depicts resume (200), which is a second version of resume (100) shown in FIG. 1. Resume (200) includes the same sections and information depicted on resume (100) with one exception—the biographical information in Biographical Section (105) on resume (100) is not depicted on resume (200). Instead, resume (200) depicts an alphanumeric string (290), instead of the biographical information. Alphanumeric string (290), also referred to herein as a “digital identifier” or an “idatafier,” is preferably a unique number assigned to each user. The digital identifier may be assigned to a user by, for example, associating the digital identifier with identifying information of the user. The digital identifier may be associated with identifying information of a user by, for example, entering the digital identifier and identifying information on a database table, and correlating them.

A user of a computer system in accordance with the present invention may be presented with an interface whereby the user may initiate creation of a resume. The resume may be saved without any request to save from the user, or may be saved only if the user requests that the resume be saved. In the alternative, when a user first accesses the computer system, a resume may already have been created and/or saved for the user. A user may be presented with the option of creating and storing more than one resume.

The user may choose to add, delete, or modify some or all of the information on a resume. There may be some information on the resume that the user cannot edit or delete. For example, if the user has earned a degree from a university, the system may receive from the university credential information that includes the university's name, the degree awarded to the user, the date that the degree was awarded, the user's grade point average, the user's class rank, whether the user graduated with honors, and/or the dates during which the user attended the university. The user may choose to include some or all of that credential information on the resume. Preferably the user would not be able to edit the credential information.

Credential information may be any information on a resume that is certified by a trusted institution. A trusted institution may be a university, corporate employer, or skills certification program. Credential information may only be accepted by computer systems according to the present invention from institutions that have been previously authorized to provide credential information. Each trusted institution may be provided an authorization code that must be provided with the credential information for the credential information to be accepted. Credential information may include information relevant to the certified resume information. For example, for a degree earned by a user of the system, the credential information may include the name of the institution that issued the degree, the date on which the degree was earned, and/or the dates that the user attended the institution.

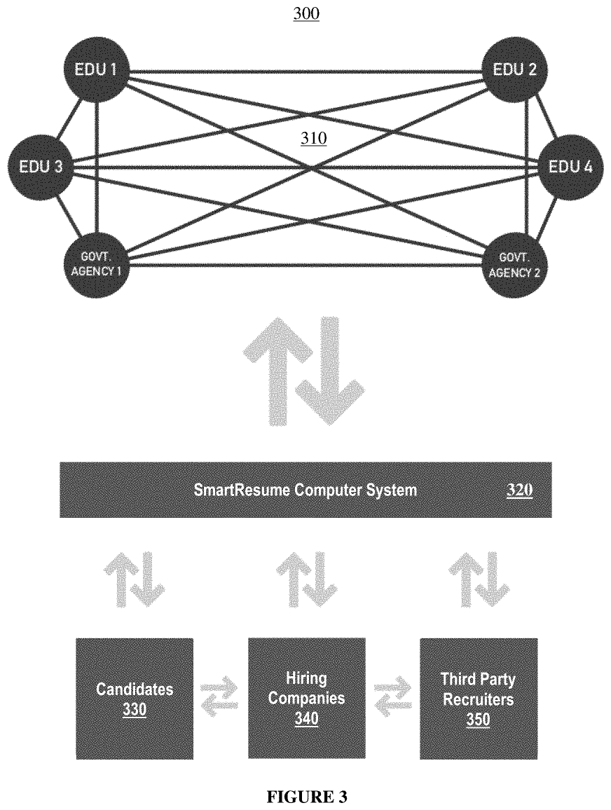

FIG. 3 depicts a flow chart (300) of information according to the present invention. At the top of the chart is a blockchain (310) maintained by four exemplary education institutions (EDU 1, EDU 2, EDU 3, and EDU 4) who may post to the blockchain credential information regarding their students and alumni. Also part of the blockchain are two government agencies (Govt. Agency 1 and Govt. Agency 2). A “SmartResume” computer system (320) in accordance with the present invention is in communication with the blockchain. Computer system (320) also receives and provides information to users of the system who are candidates (330) who may create resumes on computer system (320). Computer System (320) also receives and provides information to hiring companies (340) and third party recruiters (350) who may search for candidates (330), post job posting on the computer system, and receive resumes from candidates (330) in response to the job postings. Candidates (330) may also send resumes from the system to hiring companies (340) and third party recruiters (350) that may not have posted a job opening to, or provided information to, the computer system.

To help ensure the integrity of the credential information, the credential information may be transmitted to a blockchain ledger either by the computer system or by the institution that provides the credential information. Identifying information regarding the user about whom the credential information concerns may be sent to the blockchain with the credential information. Additionally or alternative, if the credential information is transmitted to the blockchain by a computer system according to the present invention, a digital identifier associated with the user may be sent to the blockchain with the credential information.

To the extent that any credential information is included on the resume, an icon may be depicted on the resume. As noted above, example icons (180) are shown on FIG. 1. The executable code may associate each icon (180) with credential information. The icon (180) may be depicted adjacent to the credential information above, below, or to the side of the credential information. The icon may also be depicted on the resume as a watermark. If depicted as a watermark, the icon may be partially transparent and/or may cover part of the credential information. Different icons may be presented for each section of a resume. For example, icons of different colors may be presented for each type of credential.

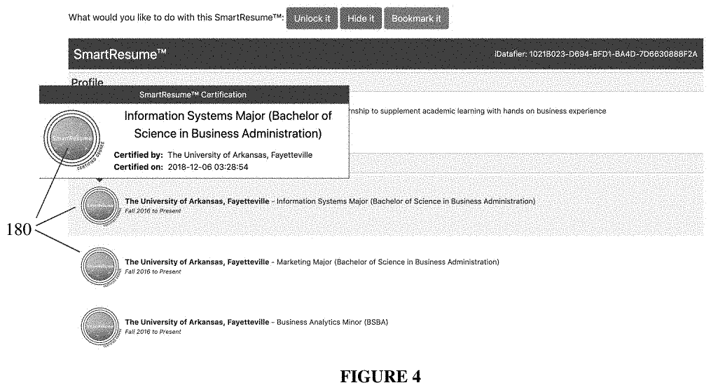

Each icon (180) may be capable of responding to an action. For example, as shown in FIG. 4, if icon (180) is selected with a computer mouse pointer, or if a computer mouse pointer hovers over icon (180), verification information relating to the credential information may be presented. The verification information may include the entity that certified the credential information, the date the credential information was certified, the time the credential information was certified, and/or a blockchain ledger date and/or time associated with the blockchain ledger entry created when the credential information is transmitted to the blockchain. By using the present invention, companies and other organizations can rely on the immutability of blockchain/distributed ledger technology to confirm key elements of resumes are certified by trusted institutions.

As shown in FIG. 4, the certification information may be presented in a separate window that may overlay a portion of the resume. In the alternative, selecting icon (180) may cause a separate screen to load, whereby the second screen may contain certification information related to the credential information.

Additionally or alternatively, selecting icon (180) may invoke other actions. For example, selecting icon (180) may submit to the computer system a search request for other resumes that include the same or similar credential information. If a user of the system selects icon (180) to submit such a search, before the search is conducted the user may be presented with a computer screen to modify the search or select options for the search. For example, if an icon (180) is associated with a degree from a particular university, the user may be offered the option to submit a search for any candidates who have received the same degree or similar from the same university, or the same degree or similar degree from any university. Additionally or alternatively, the user may be presented with the option to search for candidates who have received a degree in the same field of study, but select the level of degree, such as an Associates degree, a Bachelors degree, a Masters degree, and/or a Doctorate degree. Additionally or alternatively, the user may be presented with the option to search for candidates who received a the same degree in a particular or year or within a range of years. Additionally or alternatively, the user may be presented with the option to search for candidates by geographic area by, for example, entering a city, a state, or a zip code, or entering a certain number of miles away from a particular city, state, or zip code.

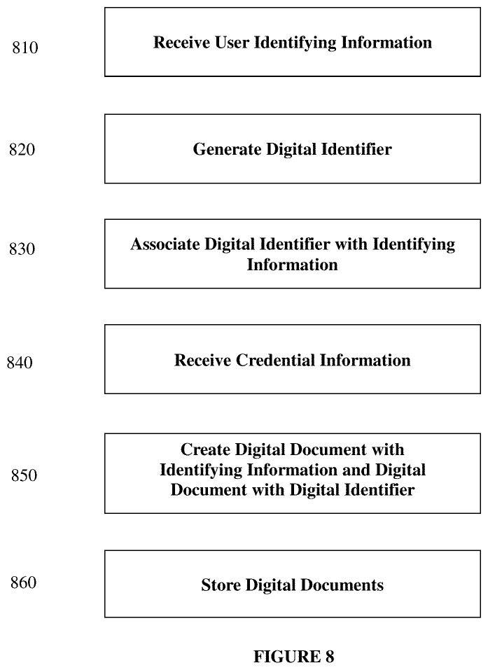

An exemplary method for verifying credentials using a computer system in accordance with the present invention is shown in FIG. 8. At Step 810, a set of identifying information corresponding to a user of the computer system is received. The set of identifying information may include the user's name, address, phone number, social security number, and/or email address. At Step 820, a first digital identifier is generated using an encryption algorithm. The encryption algorithm may be, for example, an AES algorithm. Some or all of the user's identifying information may be input to the encryption algorithm to generate the first digital identifier. At Step 830, the digital identifier is associated with information in the set of identifying information. For example, the digital identified may be associated with the user's name and/or social security number. At Step 840, a set of credential information is received. The set of credential information may be associated with information in the set of identifying information.

At Step 850, two digital documents may be created. One digital document is a resume depicting the user's identifying information. The other digital document is a resume depicting the digital identifier. At Step 860, the digital documents are stored on the computer system.

Some of the systems and methods disclosed above refer to the creation of two resumes saved as digital documents—one resume that discloses identifying information (see, e.g., FIG. 1), and one resume that discloses a digital identifier, but no identifying information (see, e.g., FIG. 2). Resumes created according to the present invention may alternatively depict both identifying information and a digital identifier. Also, the systems and methods disclosed herein can be practiced with one resume saved as a digital document. The one resume may include identifying information. When the resume is presented to a potential employer, if the resume is presented on a computer display, the computer system may hide the identifying information or replace the identifying information with a digital identifier. Alternatively, if the resume is printed, the computer system may send to the printer a version of the resume that does not include the identifying information and may insert a digital identifier on the resume.

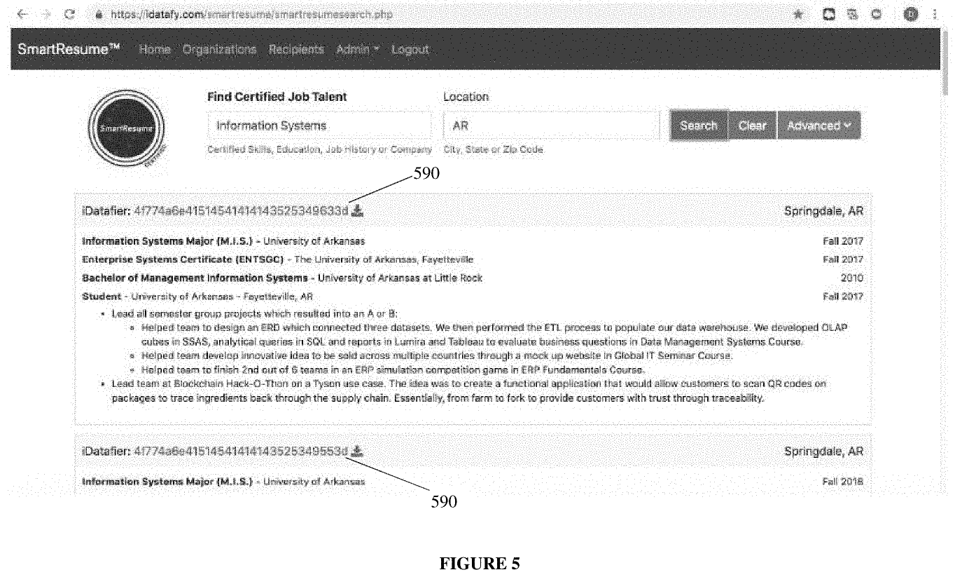

A user of the system, such as an employer, may be able to initiate a search for resumes without first selecting an icon. For example, users may be presented with a computer interface which accepts search requests. The user may be able to request resumes that meet one or more criteria, including education, experience, skills, honors, and geographic location. In response to a search request, the user may be presented with search results as shown, for example, in FIG. 5. The search results may include one or more digital identifiers (590). The user may also be presented with a portion of the information depicted on a resume of a candidate associated with the digital identifier.

Each digital identifier (590) may be a clickable link. If the user selects the link by, for example, clicking on the digital identifier (590), the user may be presented with a resume of a candidate associated with the digital identifier (590). Preferably, the resume presented to the user would depict the digital identifier, but would not disclose the identifying information of the candidate, as shown in FIG. 2. Alternatively, the resume may disclose a subset of the identifying information, such as the candidate's city and/or state. After receiving the resume depicting the digital identifier, the user may request a version of the resume with the candidate's identifying information. The system may then present to the user a resume with identifying information, as shown in FIG. 1.

The user may also request to print or transmit a resume. The request to transmit the resume may be, for example, a request to email the resume, a request to transmit the resume to another user of the system via the system, or a request to upload the resume to cloud storage system. If the user chooses to print or transmit a resume depicting identifying information, the version of the resume printed or transmitted may instead be the resume depicting the digital identifier and not depicting any identifying information.

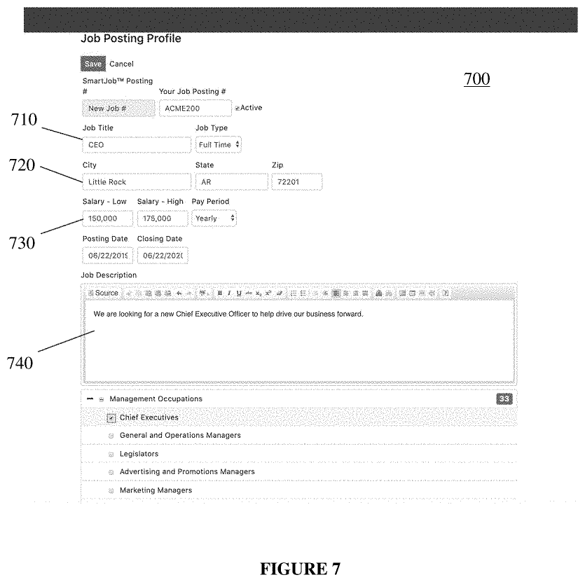

An employer may post one or more job opportunities on the computer system. The computer system may present to the user a computer interface with fields that accept information relating to each job opportunity. An exemplary computer interface (700) is shown in FIG. 7. The employer may enter information about the job opportunity in fields designated for information such as the title of the job (710), the city where the job is located (720), the salary range for the job (730), and a job description (740).

While many leading companies in the recruiting and job board placement industry rely on keyword matching to drive job search results, this process is prone to mistakes. For example, if a user enters the term “JAVA” to search for jobs opportunities for which experience writing computer programs in the JAVA computer programming language is a desired or required skill, they may get results for coffee sales, coffee baristas, and/or computer programmers. The instant system allows hiring organizations to tag a job posting and/or their company/institution with an applicable industry standard code, such as codes consistent with the North American Industry Classification System (NAICS), to allow for more precise matching. Additionally or alternatively, industry codes may be associated with credentials. Additionally or alternatively, industry codes mat be associated with the digital identifier and/or identifying information of a user to make it easier to connect certified job talent with hiring organizations in pursuit of it.

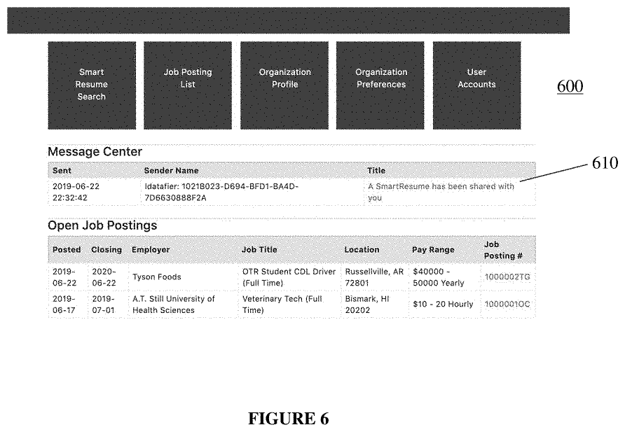

The computer system may present to a user searching for a job a computer interface that accepts search criteria. The user may enter information about the job they are seeking and request a search. Additionally or alternatively, the user may enter or select a job category to be used as a search parameter. The search may return one or more job postings, and for each posting all or some of the job information entered by the employer may be presented to the user. The user may respond to a job posting by transmitting a resume stored on the computer system to the employer that entered the job posting. The user may choose to transmit a resume that includes identifying information, or may choose to transmit a resume that includes a digital identifier. The employer may be presented a computer interface (600) as shown in FIG. 6. The interface may present a link (610) to one or more messages received from job candidates. Selecting the link may open the message from the candidate. The candidate's resume may be attached to the message.

A user may request to be alerted when a resume including one or more credentials, or a job opening including certain information is posted. The user may enter search criteria and the search criteria may be stored on the computer system. If a credentials matching the search criteria or a job posting matching the search criteria is received by the computer system, the user may be alerted. For example, an employer may set an alert by entering certain credential information to the computer system. The credential information entered by the employer may be, for example, a degree in a particular field, such as accounting. If the computer system receives a matching for credential for a user who has a resume on the computer system, the digital identifier associated with the user may be presented to the employer. The digital identifier may then be selected to retrieve the user's resume.

A user, either an employer or a candidate, may transmit a link to a resume stored on the computer system. The link may allow persons who are not users of the computer system to access a resume. Selecting the link may present the resume to the recipient of the link. For example, the link may direct the recipient of the link to a webpage maintained by the computer system that displays the resume. However, the link may only be active for a predetermined period of time. For example, 24 hours after the link is transmitted, selection of the link may no longer cause a resume to be presented. Additionally or alternatively, the link may expire after a predetermined number of selections of the link.

A user may also choose to be “forgotten” if they do not wish to have their credentials indexed and made searchable to employers or recruiters who use the computer system. Candidates may also indicate to the system which employers they are most interested in being matched with. They may also indicate the employers they do not want to be matched with.

While the invention has been described in detail with reference to embodiments for the purposes of making a complete disclosure of the invention, such embodiments are merely exemplary and are not intended to be limiting or represent an exhaustive enumeration of all aspects of the invention. It will be apparent to those of ordinary skill in the art that numerous changes may be made in such details, and the invention is capable of being embodied in other forms, without departing from the spirit, essential characteristics, and principles of the invention. Also, the benefits, advantages, solutions to problems, and any elements that may allow or facilitate any benefit, advantage, or solution are not to be construed as critical, required, or essential to the invention. The scope of the invention is to be limited only by the appended claims.

What is claimed is:

1. A system for verifying credentials comprising:
a first computer system coupled to a computer network, said first computer system including a computer memory having a machine-readable medium comprising machine-executable code recorded thereon, said machine-executable code comprising instructions for:
receiving a first set of identifying information corresponding to a first user of the first computer system, said first set of identifying information comprising the first user's name;
generating a first digital identifier using an encryption algorithm, wherein information from the first set of identifying information is input to the encryption algorithm to generate the first digital identifier;
associating the first digital identifier with information in the first set of identifying information;
receiving via the computer network a first set of credential information, wherein the first set of credential information is associated with information in the first set of identifying information;
creating a first digital document, wherein the first digital document depicts information from the first set of identifying information, information from the first set of credential information, and an icon capable of responding to an action;
creating a second digital document, wherein the second digital document depicts the first digital identifier, information from the first set of credential information, and an icon capable of responding to an action;
storing the first digital document and the second digital document on the first computer system;

2. The system of claim 1, wherein said machine-executable code further comprises instructions for:
presenting to a second user a first computer interface;
receiving from the second user by the first computer interface a first request;
presenting to the second user the first digital identifier in response to the first request;
receiving from the second user by the first computer interface a selection of the first digital identifier;
in response to selection of the first digital identifier, presenting to the second user the second digital document;
receiving from the second user a second request; and
presenting to the second user the first digital document in response to the second request.

3. The system of claim 2, wherein said machine-executable code further comprises instructions for:
receiving from the second user a third request, wherein the third request is a request to transmit the first digital document;
transmitting the second digital document in response to the third request.

4. The system of claim 3, wherein the third request is a request to transmit the first digital document to a printer.

5. The system of claim 3, wherein the third request is a request to transmit the first digital document by email.

6. The system of claim 1, wherein said machine-executable code further comprises instructions for:
receiving a first request from the first user;
generating an executable link in response to the first request;
transmitting the executable link to a second user;
presenting the second digital document to the second user in response to selection of the executable link by the second user.

7. The system of claim 6, wherein the second digital document is presented to the second user in response to selection of said executable link only if the second user selects the executable link within a predetermined period of time.

8. The system of claim 6, wherein the second digital document is presented to the second user in response to selection of said executable link only if the number of times that the executable link has been selected is less than a predetermined number of times.

9. The system of claim 1, wherein said machine-executable code further comprises instructions for:
presenting to a second user a first computer interface;
receiving from a second user a search request by the first computer interface;
storing the search request, wherein the first set of credential information is received after the search is stored;
matching information in the first set of credential information to the search request;
sending to the second user the first digital identifier.

10. The system of claim 1, wherein said machine-executable code further comprises instructions for:
transmitting a first entry to a blockchain ledger wherein the entry includes the first set of credential information and the first digital identifier;
receiving from the blockchain ledger a blockchain ledger time and date associated with the first entry;
associating the blockchain ledger time and date with the icon capable of responding to an action;
presenting the blockchain ledger time and date when the icon is selected.

11. A method for verifying credentials using a computer system, comprising:
receiving a first set of identifying information corresponding to a first user of the computer system, said first set of identifying information comprising the first user's name;
generating a first digital identifier using an encryption algorithm, wherein information from the first set of identifying information is input to the encryption algorithm to generate the first digital identifier;
associating the first digital identifier with information in the first set of identifying information;
receiving a first set of credential information, wherein the first set of credential information is associated with information in the first set of identifying information;
creating a first digital document, wherein the first digital document depicts information from the first set of identifying information, information from the first set of credential information, and an icon capable of responding to an action;
creating a second digital document, wherein the second digital document depicts the first digital identifier, information from the first set of credential information, and an icon capable of responding to an action;
storing the first digital document and the second digital document on the computer system.

12. The method of claim 11, further comprising:
presenting to a second user a first computer interface;
receiving from the second user by the first computer interface a first request;
presenting to the second user the first digital identifier in response to the first request;
receiving from the second user by the first computer interface a selection of the first digital identifier;
in response to selection of the first digital identifier, presenting to the second user the second digital document;
receiving from the second user a second request; and
presenting to the second user the first digital document in response to the second request.

13. The method of claim 12, further comprising:
receiving from the second user a third request, wherein the third request is a request to transmit the first digital document;
transmitting the second digital document in response to the third request

14. The method of claim 13, wherein the third request is a request to transmit the first digital document to a printer.

15. The method of claim 13, wherein the third request is a request to transmit the first digital document by email.

16. The method of claim 11, further comprising:
receiving a first request from the first user;
generating an executable link in response to the first request;
transmitting the executable link to a second user;
presenting the second digital document to the second user in response to selection of the executable link by the second user.

17. The method of claim 16, wherein the second digital document is presented to the second user in response to selection of said executable link only if the second user selects the executable link within a predetermined period of time.

18. The method of claim 16, wherein the second digital document is presented to the second user in response to selection of said executable link only if the number of times that the executable link has been selected is less than a predetermined number of times.

19. The method of claim 11, further comprising:
presenting to a second user a first computer interface;
receiving from a second user a search request by the first computer interface;
storing the search request, wherein the first set of credential information is received after the search is stored;
matching information in the first set of credential information to the search request;
sending to the second user the first digital identifier.

20. The method of claim 11, further comprising:
transmitting a first entry to a blockchain ledger wherein the entry includes the first set of credential information and the first digital identifier;
receiving from the blockchain ledger a blockchain ledger time and date associated with the first entry;
associating the blockchain ledger time and date with the icon capable of responding to an action;
presenting the blockchain ledger time and date when the icon is selected.
